(19) United States
(12) Patent Application Publication
(10) Pub. No.: US 2014/0063091 A1
(43) Pub. Date: Mar. 6, 2014

(54) PRINTING APPARATUS AND METHOD OF ADJUSTING PRINTING GAP

(71) Applicant: Koji Ehara, Narashino-shi (JP)

(72) Inventor: Koji Ehara, Narashino-shi (JP)

(73) Assignee: SEIKO Precision Inc., Narashino-shi, Chiba (JP)

(21) Appl. No.: 14/003,988

(22) PCT Filed: Oct. 1, 2012
(86) PCT No.: PCT/JP2012/075434

§ 371 Date: Sep. 9, 2013

(30) Foreign Application Priority Data
Dec. 6, 2011 (JP) 2011-266890

(51) Int. Cl. B41J 11/20

(52) U.S. Cl. CPC B41J 11/20
USPC 347/8

(57) ABSTRACT

A time recorder includes: a housing that has a platen; a printing unit that prints on an object to be printed, the printing unit being disposed within the housing and on the platen; and printing gap adjusters (50a). The printing gap adjusters (50a) include: rotating guide roller fixing gears (500) that are supported by side block frames (202) of the printing unit; a guide roller R disposed at a position eccentrically apart from a rotation axis of the guide roller fixing gears (500); guide portions (60) that are disposed in the housing and abut against the guide roller R in a first direction parallel with a printing direction.

### TECHNICAL FIELD

The present invention relates to a printing apparatus and a method of adjusting the printing gap.

### BACKGROUND ART

When a print head prints on a printing paper, unless the distance (hereinafter referred to as the printing gap) between the printing portion of the print head and the print side of the printing paper (or a supporting surface of a platen that supports the printing paper) is suitable, printing quality deteriorates.

For example, if the printing gap is too small (if the printing portion of the print head and the print side of the printing paper is close), a great printing pressure on the printing paper may cause ink to penetrate to the back side of the printing paper, damage printed letters, or damage the printing paper such as making a hole.

Meanwhile, if the printing gap is too large, trouble, such as blurring of printed letters and pictures, occurs.

If the travel path of a line-scanning-type print head is not parallel with the print side of the printing paper, even if the printing gap is suitably on one side of one line, the printing gap may be beyond a suitable range as the print head moves to the other side. Accordingly, this gap and inclination of the travel path of the print head relative to the print side needs to be adjusted to a suitable value.

Patent Literature 1 discloses a printing apparatus that can adjust the printing gap, a printing apparatus including a cam or a rotating eccentric shaft (a printing gap adjusting mechanism) mounted around both ends of a support shaft that slides and supports a carriage. A method of adjusting the printing gap in this printing apparatus includes rotating the cam or eccentric shaft to eccentrically rotate the support shaft, thereby changing to an arbitrary distance between the support shaft and a platen to adjust the printing gap.

Patent Literature 2 discloses a mechanism to wind an ink ribbon for supplying ink, a mechanism that includes a ribbon winding gear group disposed in a carriage, and a rack that is disposed at a frame of the printing apparatus and meshes with one gear (an input gear) of this ribbon winding gear group. Meshing of this one gear and the rack causes the ribbon winding gear group to rotate as the carriage moves, and the rotation causes the ink ribbon to be wound.

Patent Literature 1: Unexamined Japanese Patent Application Kokai Publication No. 2006-315263 and Patent Literature 2: Unexamined Japanese Patent Application Kokai Publication No. H7-304226.

### SUMMARY OF INVENTION

### Technical Problem

Suppose that the printing apparatus disclosed in Patent Literature 1 that can adjust the printing gap and includes a cam or an eccentric shaft, and the mechanism to wind the ink ribbon disclosed in Patent Literature 2 are combined.

In the combined configuration, when the printing gap is adjusted, the position of the rack that is disposed on the frame and is not secured to the support shaft of the carriage does not change, but the support shaft and the carriage (including a ribbon winding gear group) supported by the support shaft move. Therefore, adjustment of the printing gap changes the positional relationship between the input gear and the rack. Even if there is a little deviation from an optimal meshing of the input gear and the rack, the input gear can be rotated as the carriage moves. However, if the deviation is too large, friction between the input gear and the rack increases, causing trouble such as preventing the carriage from smoothly moving (sliding), and an abnormal wearing of the input gear. Therefore, adjustment of the printing gap is limited to a small amount. Accordingly, it is possible that the printing gap cannot be suitably adjusted.

In addition, in a conventional printing gap adjusting mechanism, even if the gap adjustment is set to be in a predetermined range, for example, −0.21 mm to +0.28 mm, the gap adjustment may exceed the predetermined range due to an assembly error in assembling the printing apparatus. Since, in particular, the carriage moves in a right and left direction (width direction), it may be difficult for the adjustment gap to be within the predetermined range over an entire area of movement of the carriage. In order to remedy this problem, reducing the assembly error should be considered. However, to reduce then assembly error, dimensional tolerance of each component must be reduced and processing accuracy must be increased, which increases the production cost.

The present invention was made in view of such problems and has an objective to suitably adjust the printing gap.

### Solution to Problem

In order to achieve the aforementioned objective, the printing apparatus according to a first aspect of the present invention comprises:

a housing having a platen;

a printing unit configured to print on an object to be printed, the printing unit being disposed on the platen and within the housing; and

a positioner including a rotating portion rotatably supported by either the printing unit or the housing, an eccentric portion disposed at a position eccentrically apart from a rotation axis of the rotating portion, and an abutting portion that is formed at the other of the either the printing unit or the housing and abuts against the eccentric portion in a first direction parallel with a printing direction.

The printing unit also comprises: a carriage that has an ink ribbon and a first gear and is movable along a second direction perpendicular to the first direction; and a second direction rack that extends along the second direction and meshes with the first gear, and

the first gear may be configured to rotate in response to movement of the carriage in the second direction, thereby winding the ink ribbon.

The eccentric portion preferably comprises a protrusion, and a rotatable roller supported by an outer circumference of the protrusion.

The abutting portion is preferably an edge of a slot or a protrusion, the edge of the slot or the protrusion being formed parallel with an accommodated object to be printed and orthogonal to the first direction and extending along a third direction orthogonal to the second direction perpendicular to the first direction.

The rotating portion of the positioner has a plurality of convex portions or a plurality of concave portions formed at predetermined angle intervals around the rotation axis, and

the positioner further comprises an engaging portion, the engaging portion being supported by either the printing unit or the housing and engaging with the plurality of convex portions or the plurality of concave portions.

The carriage further comprises another second direction rack extending along the second direction, and

the printing unit may comprise: a support that supports the carriage slidably in the second direction; a second gear that meshes with the other second direction rack; and a first motor that rotationally-drives the second gear.

The housing comprises: a gear group comprising at least one rotating input gear supported by the housing; a second motor that drives the input gear; a driven shaft that extends along a second direction, is secured on the center of rotation of one gear of the gear group, and rotates according to the rotation of the one gear; and driven gears disposed at both ends of the driven shaft, and

the printing unit may comprise a third direction rack being at both sides in the second direction of the printing unit, the third direction rack being on a plane parallel with an accommodated object to be printed on, extending along a third direction orthogonal to the second direction, and meshing with the driven gear.

The printing unit may have a through hole that extends along the third direction and into which the driven shaft is inserted.

A method of adjusting the printing gap according to a second aspect of the present invention uses the printing apparatus, the method comprising:

rotating a rotating portion supported by either a printing unit or a housing which is rotated to rock an eccentric portion disposed at a position eccentrically apart from a rotation axis of the rotating portion, thereby rocking an abutting portion that is formed at the other of the either the printing unit or the housing and abuts against the eccentric portion during traveling in a first direction parallel with a printing direction.

### Advantageous Effects of Invention

The present invention can suitably adjust the printing gap.

### BRIEF DESCRIPTION OF DRAWINGS

FIG. 1 is a perspective view illustrating a printing apparatus part of which is removed, according to the present embodiment;

FIG. 2 is a perspective view illustrating the printing apparatus part of which is removed, according to the present embodiment;

FIG. 3 is a perspective view illustrating a printing unit;

FIG. 4 is a perspective bottom view of the printing unit;

FIG. 5 is an enlarged perspective view illustrating a ribbon winding gear and a rack for the ribbon winding gear;

FIG. 6 is a perspective view schematically illustrating a printing gap adjuster;

FIG. 7 is a side view schematically illustrating operation of the printing gap adjuster;

FIG. 8 is a perspective view schematically illustrating a printing gap adjuster according to a first variation;

FIG. 9 is a side view schematically illustrating operation of the printing gap adjuster according to the first variation;

FIG. 10 is a perspective view schematically illustrating a printing gap adjuster according to a second variation.

### DESCRIPTION OF EMBODIMENT

Hereinafter, an embodiment of the printing apparatus according to the present invention will be described with reference to drawings, taking a time recorder as an example.

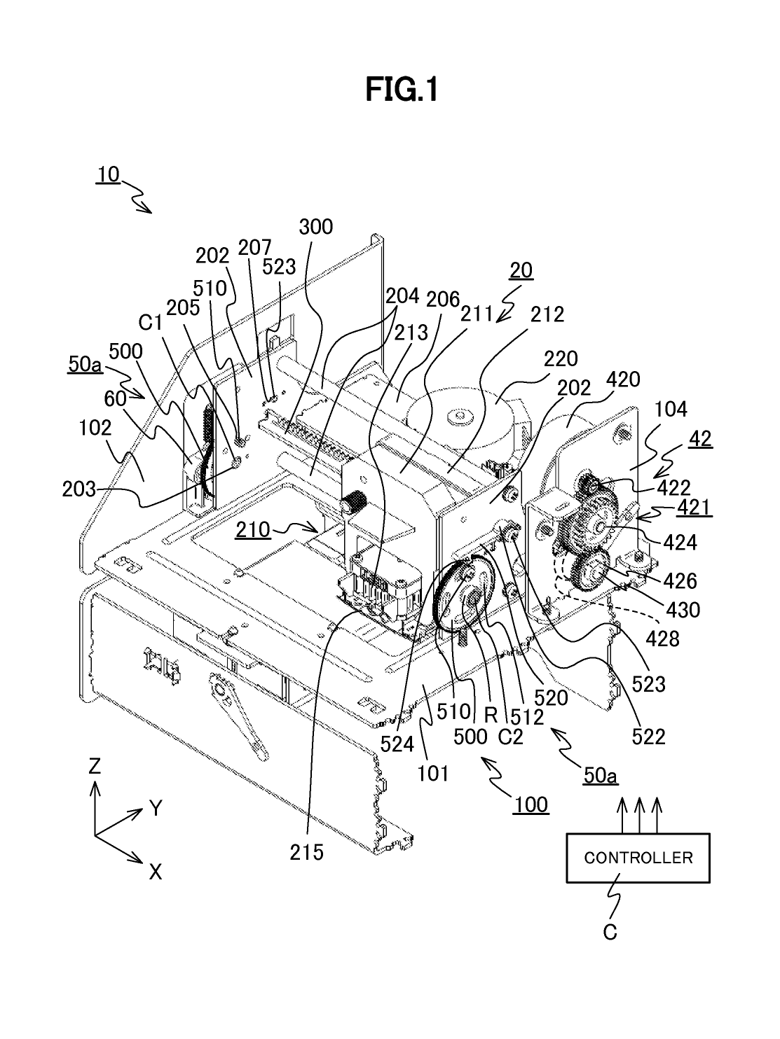

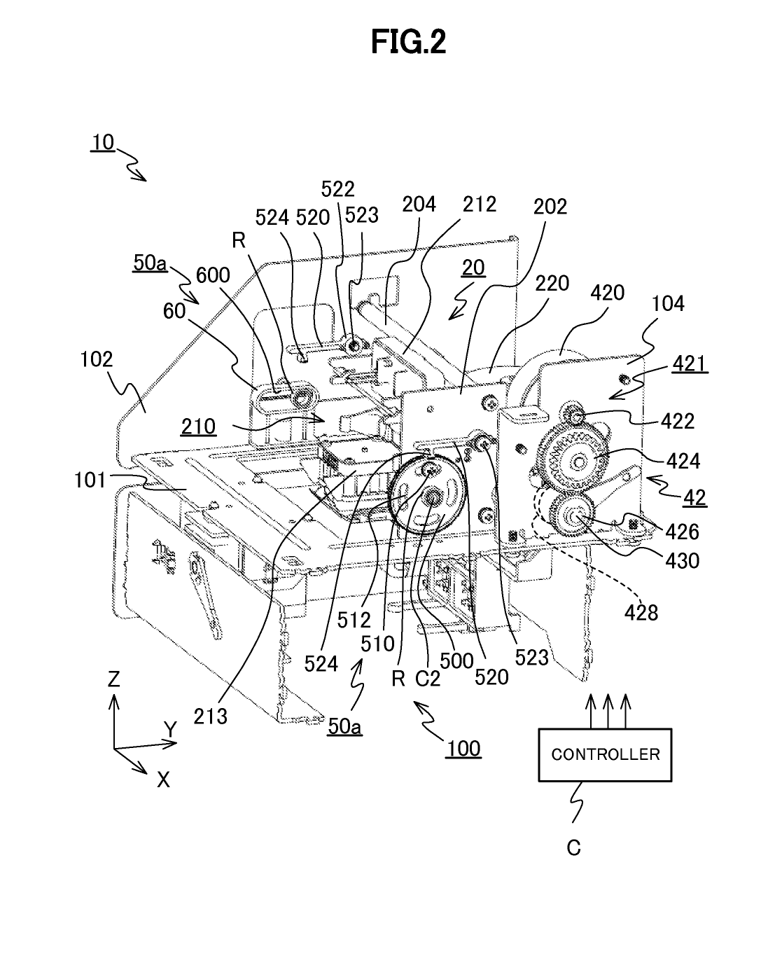

A time recorder 10 according to an embodiment of the present invention is a dot impact printing apparatus that includes a housing 100, a printing unit 20, a printing gap adjuster (positioner) 50a that adjusts the distance between the housing 100 and the printing unit 20, a front and back direction driver 42 that drives the printing unit 20 in front and back directions, and a controller C, as illustrated in FIGS. 1 and 2.

In the following description, X, Y, Z axis directions are orthogonal to one another. With respect to signs of X, Y, Z that indicate directions in drawings, a direction of an arrow is indicated by “+”, an opposite direction of the direction of an arrow is indicated by “−”, and both directions are indicated by no sign. The X axis direction corresponds to a travel direction of an after-mentioned carriage 210, and is also called right and left directions (and second direction). The Y axis direction corresponds to a conveying direction of a printing paper and an opposite direction of the conveying direction, and is also called front and back directions (and third direction). The Z axis direction corresponds to directions of an after-mentioned print head 213 close to and away from a bottom housing frame (platen) 101, and is also called a vertical direction (and first direction). Hereinafter, these components of the time recorder 10 will be described in detail.

The housing 100 includes: the plate-like bottom housing frame 101; two plate-like first-side housing frames 102 secured to both ends of the bottom housing frame 101, respectively; and a plate-like second-side housing frame 104 disposed between +X side one of the first-side housing frames 102 and +X side one of the after-mentioned side block frames 202. The bottom housing frame 101 is disposed parallel with the X-Y plane. The two first-side housing frames 102 and the second-side housing frame 104 are disposed parallel with the Y-Z plane, and protrude upward (+Z side) from the bottom housing frame 101.

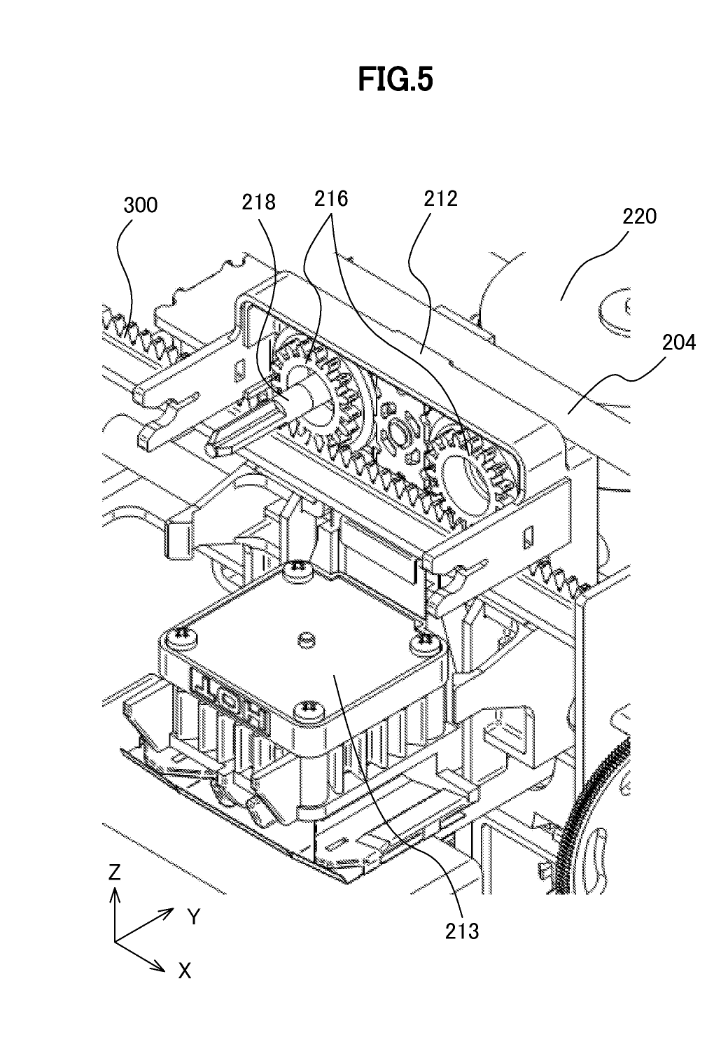

In FIGS. 1 and 2, the first-side housing frame 102 at the +X side is not illustrated so that the inside of the housing 100 can be seen. FIGS. 2 and 5 illustrate a state where an ink ribbon cartridge 211 has been removed from a cartridge loader 212. Each component in FIGS. 2 and 5 will be described in detail later. In FIG. 2, a guide roller fixing gear 500, a side block frame 202 and a rack (a second direction rack) 300 for a ribbon winding gear at the −X side are not illustrated so that a guide section 60 can be seen.

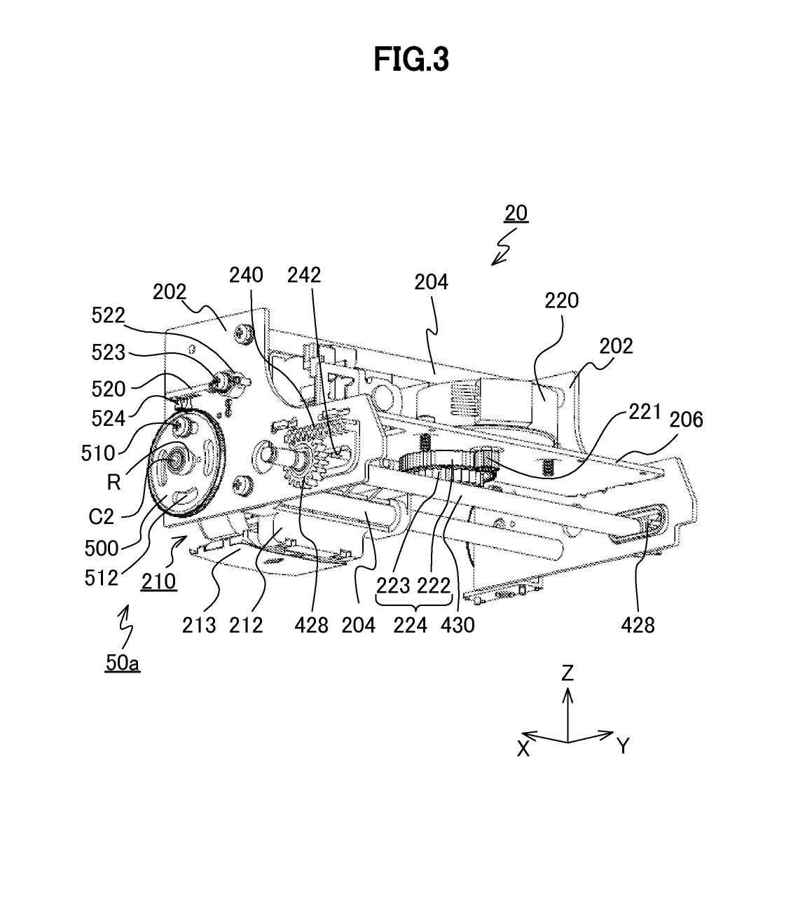

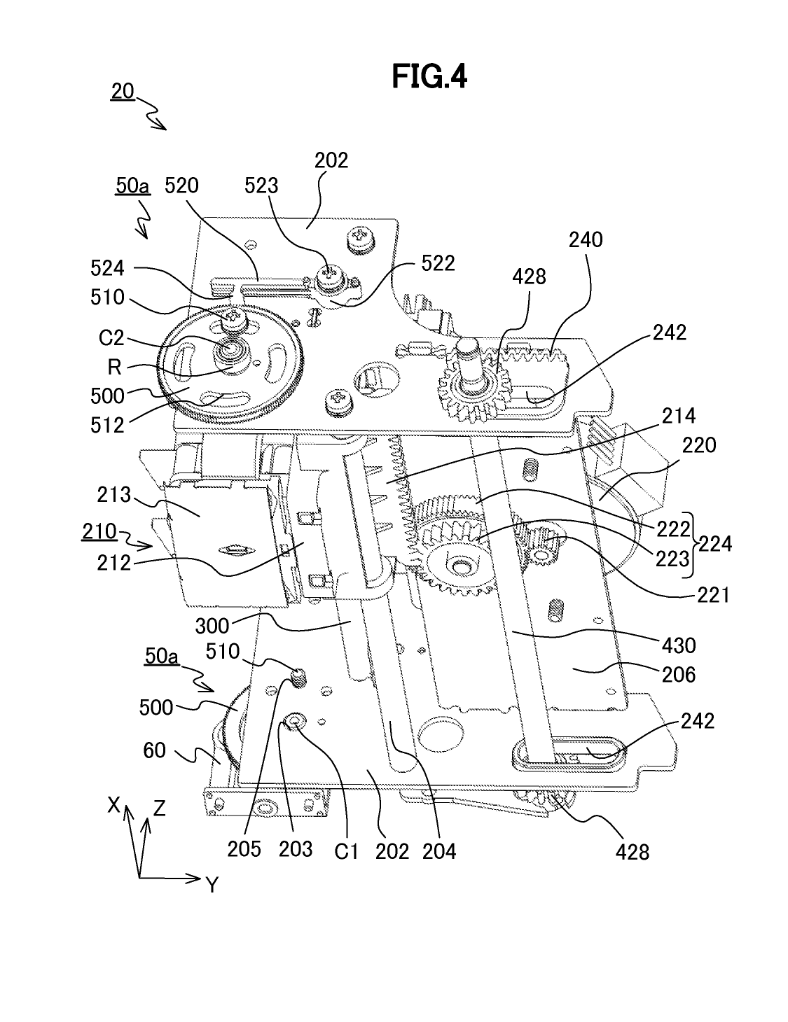

The printing unit 20 includes: the two plate-like side block frames 202; two X direction guide rods (supports) 204 that are spanned between the two side block frames 202 and whose ends are secured respectively; a carriage 210 that has a ribbon winding gear 216 (a first gear: see FIG. 5) and is supported and guided in right and left directions (the X axis direction) by the X direction guide rods 204; and the rack 300 (the second direction rack: see FIG. 5) for a ribbon winding gear, the rack 300 meshing with the ribbon winding gear 216, as illustrated in FIGS. 3 and 4.

The two side block frames 202 extend parallel with the Y-Z plane and are disposed approximately parallel to each other, each having a through hole 203 (see FIG. 1) that supports an after-mentioned center protrusion C1, a female screw hole 205 (see FIG. 1) into which an after-mentioned fixing screw 510 is screwed, and a female screw hole 207 into which an after-mentioned screw 523 is screwed. On the surface of each of the side block frames 202 that faces each of the first-side housing frames 102, is disposed the guide roller fixing gear (rotating portion) 500 that composes part of the printing gap adjuster 50a, and the center protrusion C1 formed on the rotating guide roller fixing gear 500 is supported by the hole 203. The hole 203 is not limited to a through hole and may be a concave hole as long as the hole can rotate and support the guide roller fixing gear 500.

On the outer surface of each of the two side block frames 202 (on the surface on which the guide roller fixing gear 500 is disposed) is disposed a front and back rack (a third direction rack: see FIGS. 3 and 4) 240 at the +Y side of the guide roller fixing gear 500, the front and back rack 240 meshing with an after-mentioned gear (a driven gear) 428 and extending along the Y axis direction. Rotation (normal rotation or reverse rotation) of an after-mentioned gear 428 moves the printing unit 20 in the Y axis direction via the front and back rack 240 that meshes with the gear 428, which will be described in detail later.

Toward the −Z side of the front and back racks 240 on each of the side block frames 202, is further formed one wide hole (a through hole) 242, the wide hole 242 having a little larger width than the diameter of an after-mentioned rotary shaft (driven shaft) 430 and approximately the same length as the length of the front and back racks 240 and extending along the Y axis direction. Into these two wide holes 242 is inserted the rotary shaft 430. Each of the wide holes 242 is formed longer than the amount of displacement of the print head 20 in front and back directions. Accordingly, when the print head 20 moves in front or back directions, front and back edges of the wide hole 242 do not abut against the rotary shaft 430, which does not inhibit rotation of the rotary shaft 430 (movement of the print head 20 in front and back directions).

The X direction guide rods 204 are guides for moving the carriage 210 along the X axis. The X direction guide rods 204 are composed of two rods extending along the X axis and parallel with the X-Z plane, and the both ends of the rods are secured to the two side block frames 202, respectively. (The cartridge loader 212 of) the carriage 210 is supported and slides along the X axis by the two X direction guide rods 204 in such a way that upper and lower portions of the carriage 210 are sandwiched by the two X direction guide rods 204.

The rack 300 for a ribbon winding gear extends parallel with the X direction guide rods 204 (along the X axis direction) and is spanned between the two side block frames 202, and both ends of the rack 300 are secured, respectively. The rack 300 for a ribbon winding gear meshes with the ribbon winding gear 216.

The carriage 210 includes: the ink ribbon cartridge 211 having an ink ribbon 215 therein; the cartridge loader 212 to which the ink ribbon cartridge 211 is loaded; and the print head 213 disposed below (the −Z side) the ink ribbon cartridge 211.

The cartridge loader 212 includes the ribbon winding gear 216 and a ribbon winding shaft 218, and includes an X direction rack (another second direction rack) 214 extending along the X axis parallel with a side surface at the +Y side (parallel with the X direction guide rods 204).

The ribbon winding gear 216 that can rotate and is supported by the cartridge loader 212, meshes with the rack 300 of the ribbon winding gear, and rotates as the carriage 210 moves in right and left directions (the X axis direction). This rotation of the ribbon winding gear 216 rotates the ribbon winding shaft 218, taking out the ink ribbon 215 housed and wound in the ink ribbon cartridge 211.

The X direction rack 214 meshes with an after-mentioned two-stage gear (a second gear) 224 and is provided for moving the carriage 210 in the X axis direction according to normal or reverse rotation of the two-stage gear 224.

The printing unit 20 further includes: the two-stage gear 224 that meshes with the X direction rack 214 for moving the carriage 210 in the X axis direction; and a motor (a first motor) 220 that rotationally-drives a pinion 221 that meshes with the two-stage gear 224.

The motor 220 is placed and secured on a placing board 206 spanned between the side block frames 202, and rotates a rotary shaft thereof under control of the controller C. To the rotary shaft of the motor 220 is secured the pinion 221 that protrudes downward from the placing board 206.

The two-stage gear 224 is integrally made of a small gear 223 and a large gear 222 that rotate and are supported by the placing board 206. The large gear 222 meshes with the pinion 221, and the small gear 223 meshes with the X direction rack 214.

The controller C includes a microprocessor and a motor driver circuit and the like, and rotationally-drives the motor 220 and an after-mentioned motor 420, respectively, according to a control program.

(Operation of the Carriage 210 in Right and Left Directions)

Operation of the carriage 210 in right and left directions is driven by the motor 220 under control of the controller C.

An instruction of the controller C causes the rotary shaft of the motor 220 to rotate normally or reversely. If the rotary shaft of the motor 220 rotates normally (in rotation direction in which the pinion 221 rotates in clockwise direction in FIG. 4), the two-stage gear 224 (the large gear 222) that meshes with the pinion 221 reversely rotates. At this time, the rotation speed of the two-stage gear 224 rotated by rotative power is reduced by the difference in diameter between the pinion 221 and the large gear 222. The small gear 223 integrally formed with the large gear 222 also rotates, and rotative power of the small gear 223 is converted to power to move the carriage 220 in the −X axis direction since the small gear 223 meshes with the X direction rack 214. In this way, normal rotation of the rotary shaft of the motor 220 moves the carriage 220 in the −X axis direction.

Meanwhile, if the rotary shaft of the motor 220 rotates reversely (in rotation direction in which the pinion 221 rotates in anticlockwise direction in FIG. 4), the two-stage gear 224 (the large gear 222) that meshes with the pinion 221 normally rotates. At this time, the rotation speed of the two-stage gear 224 rotated by rotative power is reduced by the difference in diameter between the pinion 221 and the large gear 222. The small gear 223 integrally engaged with the large gear 222 rotates in a unified manner, and rotative power of the small gear 223 is converted to power to move the carriage 220 in the +X axis direction since the small gear 223 meshes with the X direction rack 214. In this way, reverse rotation of the rotary shaft of the motor 220 moves the carriage 220 in the +X axis direction.

(Printing Gap Adjuster 50a)

The printing gap adjusters 50a have a function to adjust the distance between the housing 100 (the bottom housing frame 101) and the printing unit 20, and are disposed in such a way that the two printing gap adjusters 50a are arranged symmetrically at both sides of the print unit 20. Each of the printing gap adjusters 50a includes: the side block frame 202 that is part of the printing unit 20; the guide roller fixing gear 500; the guide section 60 secured on the bottom housing frame 101; and a gear fixing rack (an engaging portion) 520. The respective components of the printing gap adjuster 50a will be described in detail below.

The guide roller fixing gear 500 is a spur gear that has a center protrusion C1 that protrudes from a first surface (a surface facing the side block frame 202) and is formed on the center of rotation, an eccentric protrusion (an eccentric portion) C2 that protrudes from a second surface (a surface facing the first-side housing frame 102) and is formed at a position (eccentrically) apart from the center of rotation, four wide circular-arc holes 512 that are concentrically and uniformly arranged around the center protrusion C1, and a plurality of spur teeth on the outer circumference thereof. These spur teeth are formed for defining minimum adjustment amounts of height and inclination of the printing unit 20 relative to the housing 100, and mesh with an after-mentioned fore-end portion 524 of the gear fixing rack 520.

The guide roller fixing gear 500 is supported by (the printing unit 20 including) the side block frame 202 and is rotatable around the hole 203 in such a way that the center protrusion C1 of the guide roller fixing gear 500 is inserted into the hole 203. Around the eccentric protrusion C2 is rotatably supported a guide roller R, and the eccentric protrusion C2 and guide roller R are accommodated in an after-mentioned guide slot (an abutting portion) 600 of the guide section 60. In adjusting the printing gap, which will be described later, the guide roller R is supported and can slide in the Y axis direction by the guide slot 600, and abuts against edges of the guide slot 600 in the Z axis direction to move the printing unit 20 up and down. When the printing unit 20 moves in the Y axis direction, the guide roller R slides and contacts the guide slot 600, thereby maintaining a Z axis direction height of the printing unit 20 and smoothing Y axis direction movement of the printing unit 20. The guide roller fixing gear 500 is secured to the side block frame 202 by a fixing screw's 510 piercing through the wide holes 512 after an after-mentioned printing gap adjustment.

The guide section 60 has the elongated-hole shaped guide slot 600, and is secured on the upper surface of the bottom housing frame 101 in such a way that an traveling direction of the guide slot 600 corresponds to the Y axis direction. The guide section 60 has a function of defining the printing gap in adjusting the printing gap, which will be described later, in such a way that an edge of the guide slot 600 slides and contacts the guide roller R in the Z axis direction. The guide section 60 also guides the printing unit 20 so that the printing unit 20 moves in front and back directions approximately parallel with the bottom housing frame 101 when the front and back direction driver 42 drives the printing unit 20 in front and back directions. The front and back direction length of the guide slot 600 is sufficiently longer than the range of back and forth movement of the printing unit 20 that is defined by the length of the wide hole 242 so as not to prevent back and forth movement of the printing unit 20.

The gear fixing rack 520 is made of an elastic material, and has a base portion 522, and the fore-end portion 524 having a rack that meshes with teeth of the guide roller fixing gear 500. A pitch of a plurality of protrusions (grooves) formed on the rack is the same as the pitch of grooves (teeth) of the guide roller fixing gear 500. The base portion 522 of the gear fixing rack 520 is secured on (supported by) the outer surface of the side block frame 202. This support is achieved in such a way that the screw 523 pierces through the base portion 522 of the gear fixing rack 520 and is screwed into the female screw hole 207 formed in the side block frame 202. An elastic force (a restoring force) of the gear fixing rack 520 keeps the mesh of the fore-end portion 524 with the teeth of the guide roller fixing gear 500.

The minimum set value of the rotation angle of the guide roller fixing gear 500 is one pitch of a tooth since the teeth of the guide roller fixing gear 500 mesh with the gear fixing rack 520 to define the rotation angle. Accordingly, the smaller the pitch of teeth of the guide roller fixing gear 500 becomes, in other words, the larger the number of teeth becomes (or the larger the diameter of the gear becomes and the smaller each tooth becomes), the smaller the minimum set value of the rotation angle becomes.

(Method of Adjusting Printing Gap Using Printing Gap Adjuster 50a)

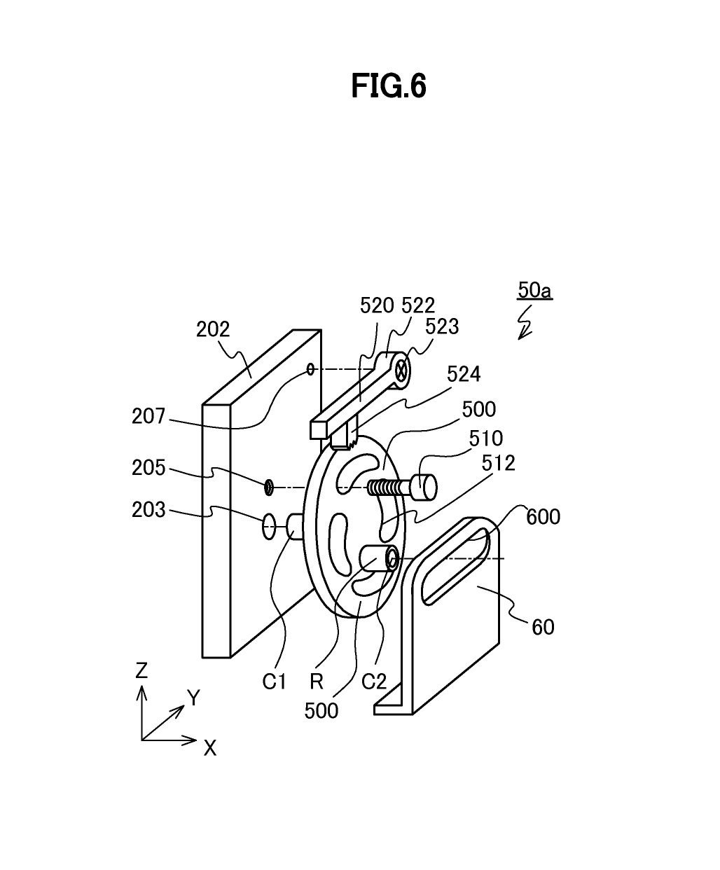

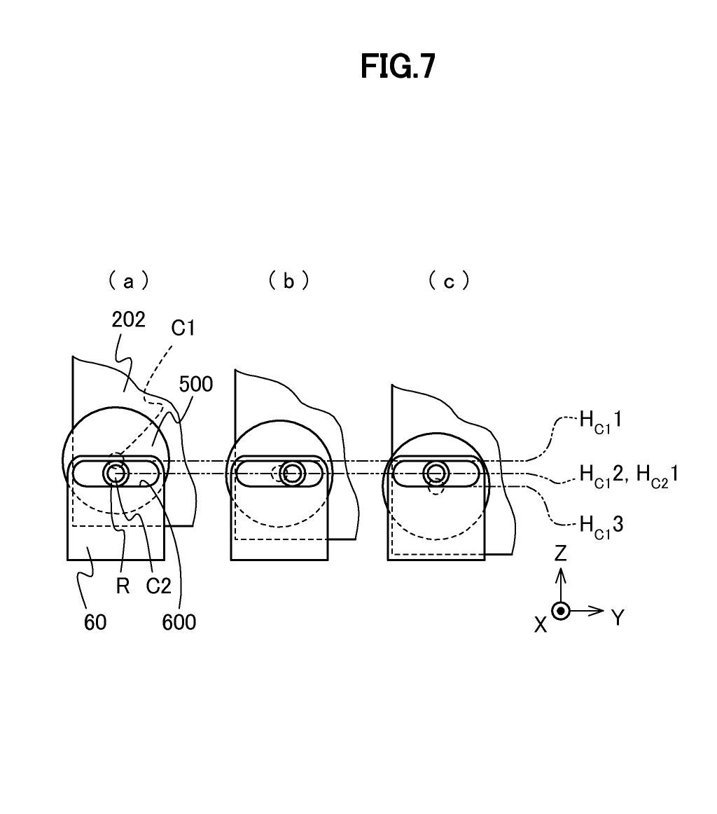

Next, a method of adjusting the printing gap using the printing gap adjuster 50a will be described in reference with FIGS. 6 and 7. In drawings, a different reduction scale from an actual reduction scale is used. In particular, the distance between the center protrusion C1 and the eccentric protrusion C2 (corresponds to an eccentric amount and is equal to the distance between H_{c1}1 and H_{c2}1) is shown longer than the actual length thereof. An actual eccentric amount is up to approximately 0.2 mm. For example, if an eccentric amount is 0.2 mm, the printing gap can be adjusted in the range of −0.2 mm to +0.2 mm.

First, the time recorder 10 is provided that includes the printing unit 20, the two rotatable guide roller fixing gears 500 supported by the printing unit 20, and the two guide sections 60, each of which can slide and support each of the two guide roller fixing gears 500.

Then, the guide roller fixing gear 500 is rotated in such a way that force in the rotational direction is applied to the guide roller fixing gear 500 to release an elastic contact of the gear fixing rack 520.

When the guide roller fixing gear 500 rotates, the eccentric protrusion C2 and the guide roller R rotate eccentrically relative to the center protrusion C1 that is the center of rotation. The guide roller R, as illustrated in FIG. 7, is movable in front and back directions within a length of the guide slot 600 but does not move beyond clearance formed for slide in the vertical direction due to upper and lower edges of the guide slot 600.

As described above, the guide section 60 (having the guide slot 600) that supports the guide roller R is secured on the bottom housing frame 101. Meanwhile, the printing unit 20 (having the hole 203) that supports the center protrusion C1 is not secured on the bottom housing frame 101. That is, as illustrated in FIG. 7, when the guide roller fixing gear 500 rotates, the guide roller R (the eccentric protrusion C2) supported by the guide section 60 does not move in vertical direction relative to the bottom housing frame 101 (always stays at the height of H_{c2}1 in FIG. 7), and the center protrusion C1 moves in vertical direction relative to the bottom housing frame 101 (moves to a height such as H_{c1}1, H_{c1}2 and H_{c1}3 in FIG. 7).

As a result, the entire printing unit 20 to which the guide roller fixing gear 500 is mounted moves in the Z axis direction. The distance (a gap) between the printing unit 20 and the bottom housing frame 101 (a platen) changes according to the amount of this movement in the Z axis direction of the printing unit 20.

Next, adjustment is performed by rotating both guide roller fixing gears 500 so that both sides in the X axis direction of the printing unit 20 are parallel with the upper surface of the bottom housing frame 101 and have a desired distance (a desired printing gap) relative to the bottom housing frame 101 within a movable range of the printing unit 20 in the X axis direction. After that, the two fixing screws 510 pierce through the wide holes 512 formed in the respective guide roller fixing gears 500 to be screwed into the female screw holes 205 thereby to secure the guide roller fixing gears 500 to the side block frames 202, completing adjustment of the printing gap.

In this method of adjusting the printing gap, the carriage 210 including the ribbon winding gear 216 and the rack 300 for the ribbon winding gear integrally move within the whole printing unit 20. Therefore, in adjusting the printing gap, the positional relationship between the ribbon winding gear 216 and the rack 300 for the ribbon winding gear does not change. That is, adjustment of the printing gap does not cause the ribbon winding gear 216 and the rack 300 for the ribbon winding gear to move away from each other and does not unlock their meshing state, thereby allowing for an increase of the adjustment range of the printing gap. Specifically, the adjustment range of the printing gap can be increased by making the eccentric protrusion C2 far apart from the center protrusion C1.

Gap adjustment is performed at the factory, and is not performed by a user. Therefore, the distance between the bottom end of the print head and the upper surface of the printing paper changes depending on the thickness of the printing paper. However, since gap adjustment is performed by taking the change in distance into consideration, trouble does not occur as long as the paper has a thickness within an expected range.

(Front and Back Direction Driver 42 of Printing Unit 20)

Next, in reference to FIGS. 1 to 3, the front and back direction driver 42 that causes the printing unit 20 to be movable in the Y axis direction will be described.

The front and back direction driver 42 mainly includes: a reduction gear group 421; the motor (a second motor) 420 that rotationally-drives the reduction gear group 421 under control of the controller C; the rotary shaft 430 that rotates in conjunction with rotation of the reduction gear group 421; and the gear 428 secured to the outer circumference of the rotary shaft 430.

The motor 420 includes a rotary shaft that is rotatable normally and reversely, and is secured to the second-side housing frame 104. To the rotary shaft of the motor 420 is secured a pinion (an input gear) 422.

The reduction gear group 421 that rotates and is supported by the second-side housing frame 104, and includes the pinion 422, an intermediate gear 424 that meshes with the pinion 422, and an output gear 426 that meshes with the intermediate gear 424.

The intermediate gear 424 has a larger diameter and a larger number of teeth than those of the pinion 422. The rotation speed of the rotary shaft of the motor 420 is significantly reduced by the pinion's 422 meshing with the intermediate gear 424.

The output gear 426 has a D-shaped center hole formed in the center thereof, and into the center hole is fitted the rotary shaft 430. That is, rotation of the intermediate gear 424 rotates the rotary shaft 430 via the output gear 426.

The rotary shaft 430 pierces the wide holes 242 formed in both side block frames 202 and extends along the X axis direction so as to pass through the printing unit 20, and to outer ends of the rotary shaft 430 that protrude from the side block frames 202 are secured the gears 428 that mesh with the front and back rack 240.

(Operation of Front and Back Direction Driver 42 of Printing Unit 20)

Next, operation of the front and back direction driver 42 configured in this way will be described. An instruction from the controller C rotates the rotary shaft of the motor 420 normally or reversely. First, if the rotary shaft of the motor 420 rotates normally (in rotation direction in which the pinion 422 rotates in clockwise direction in FIGS. 1 and 2), rotative power is transmitted to the pinion 422, reduction gear group 421, rotary shaft 430 and gear 428 in this order, thereby rotating the gear 428 normally. Further, rotative power of the gear 428 is converted to power to move the printing unit 20 in the +Y axis direction since the gear 428 meshes with the front and back rack 240. This normal rotation of the rotary shaft of the motor 420 moves the printing unit 20 in the +Y axis direction.

Meanwhile, if the rotary shaft of the motor 420 rotates reversely (in rotation direction in which the pinion 422 rotates in anticlockwise direction in FIGS. 1 and 2), rotative power is transmitted to the pinion 422, reduction gear group 421, rotary shaft 430 and gear 428 in this order, thereby rotating the gear 428 reversely. Further, rotative power of the gear 428 is converted to power to move the printing unit 20 in the −Y axis direction since the gear 428 meshes with the front and back rack 240. This reverse rotation of the rotary shaft of the motor 420 moves the printing unit 20 in the −Y axis direction.

Since the printing unit 20 moves in the conveying direction of the printing paper (the Y axis direction) as described above in response to an instruction of the controller C, only space is required so that the printing unit 20 can move within an area of the printing paper, which can reduce space required for the printing paper to move in the Y axis direction, compared with an apparatus whose printing unit 20 cannot move. As a result, the time recorder 10 can be downsized.

(First Variation)

In the above printing gap adjuster 50a, the guide section 60 having the guide slot 600 that is a wide hole is fixed to the guide roller R. It has been described that the printing gap adjuster 50a is configured to include: the guide roller fixing gear 500 in which the guide roller R that can slide and is supported by the guide slot 600; and the side block frame 202 whose hole 203 rotates and supports the center protrusion C1 of the guide roller fixing gear 500. However, the present invention is not limited to this configuration.

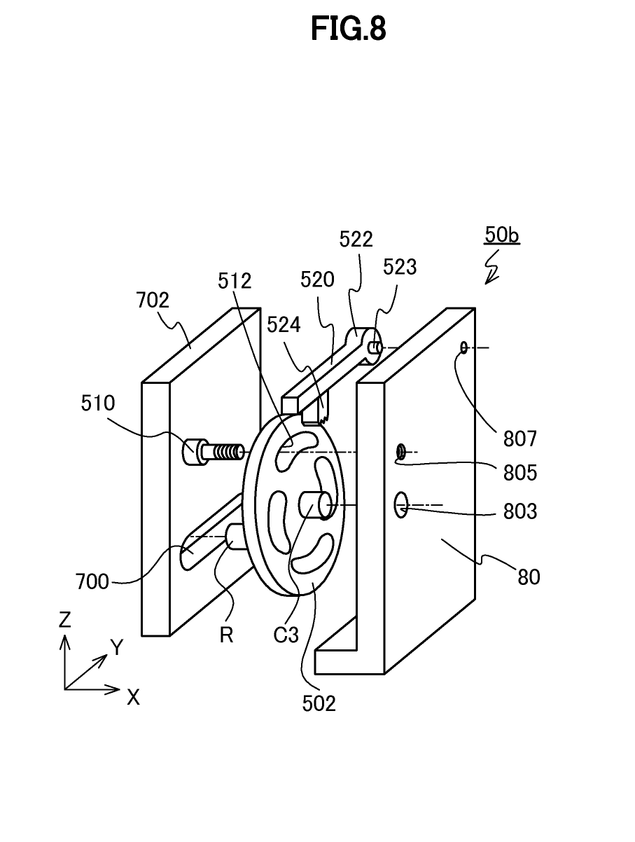

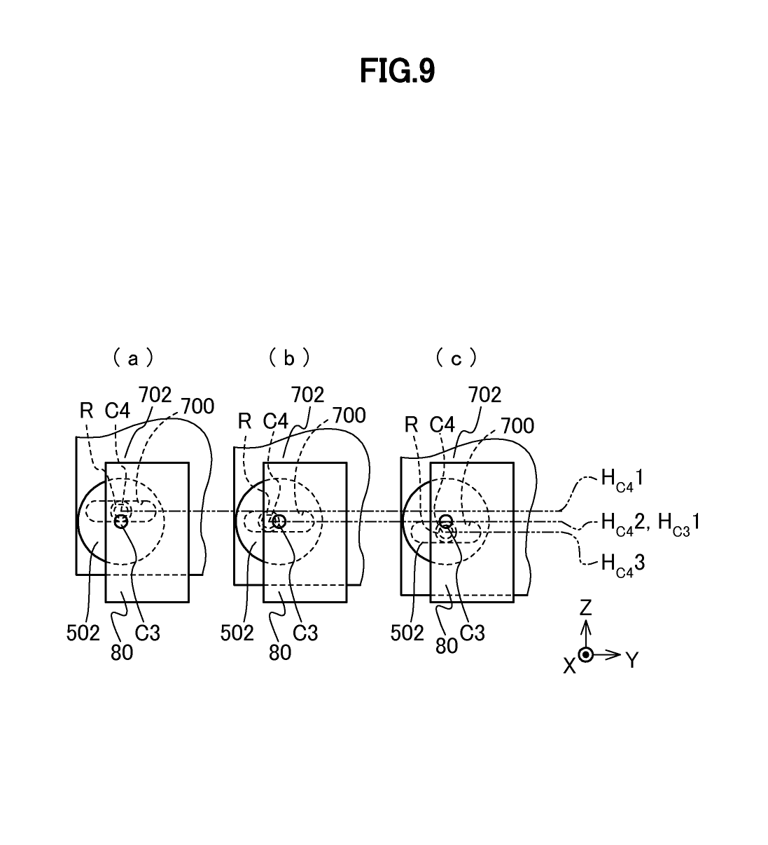

For example, the support relationship between the guide section 60 and the guide roller R and the support relationship at the side block frame 202 at the center protrusion C1 side may be replaced by each other. A printing gap adjuster (a positioner) 50b having this configuration according to the first variation will be described with reference to FIGS. 8 and 9. Any nearly the same function and configuration as those of the time recorder 10 according to the above embodiment will not be described and indicated by the same reference numbers in order to clarify differences.

The printing gap adjuster 50b according to the first variation includes: a third-side housing frame 80 secured on the bottom housing frame 101; a guide roller fixing gear (a rotating portion) 502; a side block frame 702 that is part of the printing unit 20; and the gear fixing rack 520. These components, two of each, are symmetrically disposed at both sides of the print head 20. Each component of the printing gap adjuster 50b will be described in detail below.

The two third-side housing frames 80 extend along the Y-Z plane and are disposed approximately parallel with each other, and each of the third-side housing frames 80 has a through hole 803 that supports an after-mentioned center protrusion C3, and a female screw hole 805 into which the fixing screw 510 is screwed. On surfaces of the two third-side housing frames 80 that face the side block frames 702 are disposed the guide roller fixing gears 502, and the center protrusions C3 formed on the guide roller fixing gears 502 that rotate and are supported by the holes 803. The holes 803 are not limited to through holes, but may be concave holes as long as the holes 803 allow to rotate and support the guide roller fixing gears 502.

The guide roller fixing gear 502 is a spur gear that has an eccentric protrusion C4 that protrudes from the first surface (a surface facing the side block frame 702) and is formed at a position (eccentrically) apart from the center of rotation, the center protrusion C3 that protrudes from the second surface (a surface facing the third-side housing frame 80) and is formed on the center of rotation, and the four wide circular-arc holes 512 that are concentrically and uniformly arranged around the center protrusion C3.

The guide roller fixing gear 502 is supported by (the housing 100 including) the third-side housing frame 80 and is rotatable around with respect to the hole 803 in such a way that the center protrusion C3 is inserted into the hole 803. Around the eccentric protrusion C4 is rotatably supported the guide roller R, and the eccentric protrusion C4 and guide roller R are inserted into an after-mentioned guide slot (an abutting portion) 700 of the side block frame 702. In adjusting the printing gap, which will be described later, the guide roller R can slide and is supported in the Y axis direction by the guide slot 700, and abuts against edges of the guide slot 700 in the Z axis direction to move the printing unit 20 up and down. When the printing unit 20 moves in the Y axis direction, the guide roller R slides and contacts the guide slot 700 thereby to keep the Z axis direction height of the printing unit 20 and smooth movement of the printing unit 20 in the Y axis direction. The guide roller fixing gear 500 is secured to the third-side housing frame 80 by the fixing screw's 510 being screwed into the female screw hole 805 after the printing gap is adjusted.

The two side block frames 702 extend along the Y-Z plane, are disposed approximately parallel with each other, and have the elongated-hole shaped guide slots 700 extending along the Y axis direction. In adjusting the printing gap, the guide slot 700 supports the center protrusions C4 formed on the guide roller fixing gears 502 and the guide roller R slides in the Y axis direction.

The base portion 522 of the gear fixing rack 520 is secured (supported) by the screw 523 to an outer surface of the third-side housing frame 80.

(Method of Adjusting Printing Gap Using Printing Gap Adjuster 50b)

Next, a method of adjusting the printing gap using the above printing gap adjuster 50b will be described with reference to FIGS. 8 and 9.

First, the time recorder 10 is provided that includes the two third-side housing frames 80; two guide roller fixing gears 502, each being rotatably supported by each of the two third-side housing frames 80; and the printing unit 20 that slides and supports the two guide roller fixing gears 502.

Next, the guide roller fixing gear 502 is rotated in such a way that force in rotation direction is applied to the guide roller fixing gear 502 so as to release an elastic contact of the gear fixing rack 520.

Rotation of the guide roller fixing gear 502 causes the eccentric protrusion C4 and the guide roller R to rotate eccentrically relative to the center protrusion C3 that is the center of rotation. The guide roller R is movable in front and back directions within a range of the length of the guide slot 700, but does not move vertically beyond clearance provided for slide due to upper and lower edges of the guide slots 700, as illustrated in FIG. 9.

The third-side housing frame 80 (having the hole 803) that supports the center protrusion C3 is secured on the bottom housing frame 101, as described above. Meanwhile, the printing unit (the side block frame 702) (having the guide slot 700) that supports the guide roller R is not secured on the bottom housing frame 101. That is, as illustrated in FIG. 9, when the guide roller fixing gear 502 rotates, the center protrusion C3 does not move vertically relative to the bottom housing frame 101 (always stays at the height of H_{c3}1 in FIG. 9) since the third-side housing frame 80 is secured on the bottom housing frame 101 and the center protrusion C3 is supported by the third-side housing frame 80. Meanwhile, since the guide roller R (the eccentric protrusion C4) is eccentrically disposed relative to the center protrusion C3 that is the center of rotation, the center protrusion C3 moves onto a concentric circle whose radius is a center distance to the center protrusion C3. In FIG. 9, the height of the guide roller R relative to the bottom housing frame 101 changes to H_{c4}1, H_{c4}2, H_{c4}3 and the like.

As a result, the entire printing unit 20 (includes the side block frame 702) that has the guide slot 700 that abuts in the Z axis direction moves in the Z axis direction by the same amount as movement of the guide roller R in the Z axis direction. Depending on this amount of movement of the printing unit 20 in the Z axis direction, the distance (a gap) between the printing unit 20 and the bottom housing frame 101 (platen) changes.

Next, the guide roller fixing gears 502 at both sides are adjusted so that (the side block frames 702 of) at both sides of the printing unit 20 are parallel with the upper surface of the bottom housing frame 101 and has the desired distance (a desired printing gap) relative to the bottom housing frame 101. After that, the two fixing screws 510 pierce the respective wide holes 512 formed in the guide roller fixing gears 502 and are screwed into the respective female screw holes 805, thereby securing the guide roller fixing gears 502 to the third-side housing frames 80 and completing adjustment of the printing gap.

In this method of adjusting the printing gap, the printing unit 20 including the carriage 210 having the ribbon winding gear 216 built-in and the rack 300 for a ribbon winding gear move in a unified manner. Therefore, in adjusting the printing gap, the positional relationship between the ribbon winding gear 216 and the rack 300 for the ribbon winding gear does not change. That is, adjustment of the printing gap does not cause the ribbon winding gear 216 and the rack 300 for the ribbon winding gear to move away from each other. Accordingly, since the mesh state is not unlocked, the adjustment range of the printing gap can be increased with mesh while the ribbon winding gear 216 and the rack 300 for the ribbon winding gear is suitably maintained. Specifically, the adjustment range of the printing gap can be increased by making the eccentric protrusion C4 far apart from the center protrusion C3.

The printing gap is adjusted in assembling the product, not by a user. Therefore, the distance between the bottom end of the head and the upper surface of the printing paper changes depending on the thickness of the printing paper. However, since the printing gap is adjusted, taking the change of distance into consideration, trouble does not occur as long as the printing paper has a thickness within an expected range.

(Second Variation)

In the above configuration, what abuts against the guide roller R (of the guide roller fixing gear 502) in the Z axis direction is an edge of the guide slot 700 (of the side block frame 702), but the present invention is not limited to this configuration.

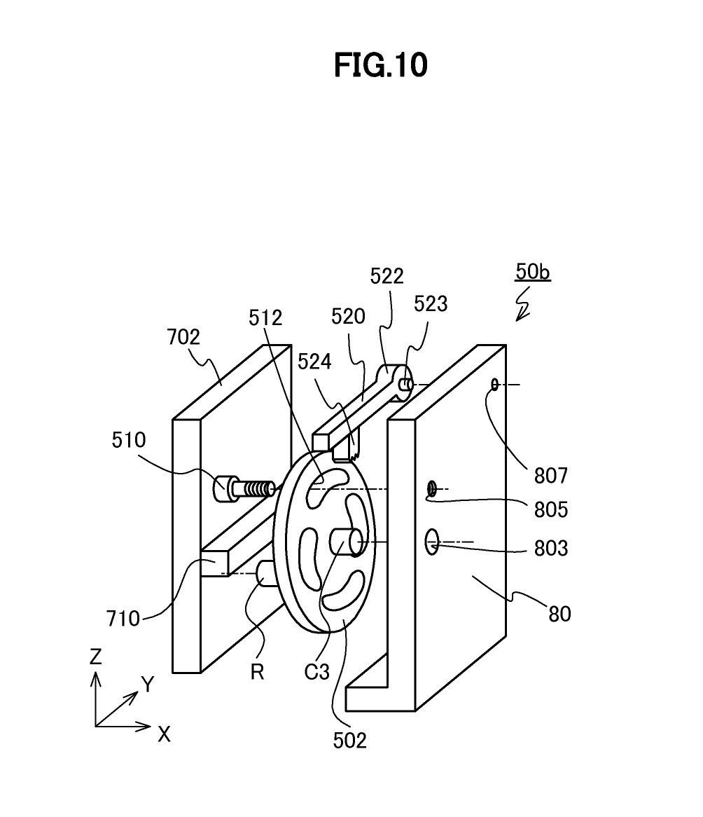

Specifically, in the present invention, the guide roller fixing gear 502 and the side block frame 702 need to abut against each other in the Z axis direction and what abuts against the guide roller R needs to slide in the Y axis direction. For example, as illustrated in FIG. 10, a protrusion (abutting portion) 710 that protrudes in the +X axis direction and extends along the Y axis direction may be employed. In this case, due to the driving and driven relationship with the guide roller R, the protrusion 710 is formed in such a way that the bottom surface of the protrusion 710 abuts against the guide roller. By being formed in this way, in adjusting the printing gap, eccentric rotation of the guide roller R causes the print head 20 to move up and down due to the print head's 20 own weight while the protrusion 710 is always in contact with the guide roller R. That is, the position of the print head 20 can be adjusted according to the position of the guide roller R.

In this way, a configuration that includes the protrusion 710 instead of the guide slot 700 may be applied to the guide slot 600 according to the above embodiment. In this case, like the above, due to the driving and driven relationship with the guide roller R, the protrusion is formed in such a way that the upper surface of the protrusion abuts against the guide roller R.

In the above embodiment, it has been described that the guide roller fixing gear 500 rotates and is supported by the side block frame 202 by inserting the center protrusion C1 into the hole 203. However, the present invention is not limited to this configuration. For example, a protrusion and a hole that supports the protrusion may be formed vice versa as long as the guide roller fixing gear 500 is rotatable relative to the side block frame 202. Specifically, the present invention may be configured in such a way that the side block frame 202 includes a protrusion, the protrusion is fitted into a center hole of the rotating guide roller fixing gear 500 that supports rotatably the guide roller fixing gear 500.

Similarly, with respect to the center protrusion C3 of the guide roller fixing gear 502 and the hole 803 of the third-side housing frame 80 according to the first variation, the protrusion and the hole that supports the protrusion may be formed vice versa.

As described above, in adjusting the printing gap by the time recorder 10 according to the present embodiment, since the printing unit 20 can move up and down by rotating the guide roller fixing gear 500, 502, mesh between the rack and the gear that are provided within the printing unit 20 can be stably maintained.

In addition, the guide roller fixing gears 500 are disposed at both right and left ends of the printing unit 20. Therefore, by making rotations of the right and left guide roller fixing gears 500 different from each other, an inclination in right and left directions of the printing unit 20 can be easily corrected so that the printing gap is uniform.

Further, the guide roller R which rotates and is supported by the eccentric protrusions C2 or C4 reduces friction in moving the print head 20 up and down, thereby easily adjusting the printing gap. Further, the guide roller R rotates according to front and back movement of the print head 20, thereby smoothing front and back movement of the print head 20.

In addition, the gear fixing rack 520 in elastic contact with the teeth of the guide roller fixing gear 500, 502 provides a clicking touch to an operator, and keeps the guide roller fixing gear 500, 502 at a predetermined rotation angle, thereby easily setting a desired angle, that is, easily adjusting the printing gap.

Further, the front and back direction driver 42 that drives the print head 20 in front and back directions can actively operate the print head 20 relative to the printing paper. This can reduce space for accommodating printing paper, and can downsize the time recorder 10.

In the front and back direction driver 42, the motor 220 rotationally-drives, via the reduction gear group 421, the rotary shaft 430 and the gear 428 secured to the rotary shaft 430, thereby moving, via the front and back racks 240 that mesh with the gear 428, the printing unit 20 in front and back directions. The rotary shaft 430 is disposed so as to pierce the wide holes 242 provided at both sides of the printing unit 20, and the gear 428 and the front and back racks 240 mesh with each other at both outer sides of the wide holes 242.

This configuration can move the printing unit 20 parallel in front and back directions with the motor 220 and reduction gear group 421 disposed at only one side, which reduces the number of components.

For example, it has been described that the guide roller fixing gear 500 has spur teeth in the outer circumference thereof. A plurality of convex portions or a plurality of concave portions may be employed instead of spur teeth as long as the convex or concave portions mesh (engage) with the fore-end portion 524 of the gear fixing rack 520 at a predetermined pitch.

It has been described that the gear fixing rack 520 is made of an elastic material and is in elastic contact with the guide roller fixing gear 500. However, the present invention is not limited to this configuration as long as engagement with the guide roller fixing gear 500 is achieved. For example, a configuration may be employed in which the gear-fixing rack is not secured to but rotates and is supported by the side block frame or the third-side housing frame, and a coil spring is secured to the gear-fixing rack and the side block frame or the third-side housing frame. In this case, the gear-fixing rack does not need to be made of an elastic material, and engagement of the gear-fixing rack and the guide roller fixing gear 500 can be maintained by power due to the restoring force of the coil spring.

Further, the time recorder according to the present invention may include a guide roller fixing gear without spur teeth at the outer circumference thereof instead of a gear-fixing rack as long as the printing gap can be adjusted by vertical movement of the printing unit. That is, it is optional to include a function defining the minimum adjustment amounts of height and inclination of the printing unit.

In the above embodiment, an example has been described in which the present invention is applied to a dot impact time recorder, but the present invention may be applied to a heat-transfer type apparatus, and may be applied to a printer, facsimile and other printing apparatuses that require printing gap adjustment.

Various embodiments and variations of the present invention can be made without departing from the general spirit and scope of the present invention. The above embodiment is intended for describing the present invention, not limiting the scope of the present invention. That is, the scope of the present invention is defined by not the embodiment but claims. Various variations within claims and within the meaning of the invention equivalent to claims shall be included by the present invention.\

The present application is based on Japanese Patent Application No. 2011-266890 filed on Dec. 6, 2011. The entire specification, claims and drawings of Japanese Patent Application No. 2011-266890 are incorporated herein by reference.

### REFERENCE SIGNS LIST

10 Time recorder (Printing apparatus)
100 Housing
101 Bottom housing frame (Platen)
20 Printing unit
204 X direction guide rod (Support)
210 Carriage
214 X direction rack (Another second direction rack)
215 Ink ribbon
216 Ribbon winding gear (First gear)
220 Motor (First motor)
224 Two-stage gear (Second gear)
240 Front and back rack (Third direction rack)
242 Wide hole (Through hole)
300 Rack for ribbon winding gear (Second direction rack)
420 Motor (Second motor)
422 Pinion (Input gear)
428 Gear (Driven gear)
430 Rotary shaft (Driven shaft)
50a, 50b Printing gap adjuster (Positioner)
500, 502 Guide roller fixing gear (Rotating portion)
520 Gear-fixing rack (Engaging portion)
600, 700 Guide slot (Abutting portion)
710 Protrusion (Abutting portion)
C Controller
C1, C3 Center protrusion (Rotation axis)
C2, C4 Eccentric protrusion (Eccentric portion)
R Guide roller (Eccentric portion)

1. A printing apparatus comprising:
a housing having a platen;
a printing unit configured to print on an object to be printed, the printing unit being disposed on the platen and within the housing; and
a positioner including a rotating portion rotatably supported by either the printing unit or the housing, an eccentric portion disposed at a position eccentrically apart from a rotation axis of the rotating portion, and an abutting portion that is formed at the other of the either the printing unit or the housing and abuts against the eccentric portion in a first direction parallel with a printing direction.

2. The printing apparatus according to claim 1, wherein the printing unit comprises a carriage that has an ink ribbon and a first gear and is movable along a second direction perpendicular to the first direction; and a second direction rack that extends along the second direction and meshes with the first gear,
the first gear rotating in response to movement of the carriage in the second direction, thereby winding the ink ribbon.

3. The printing apparatus according to claim 1, wherein the eccentric portion comprises a protrusion, and a rotatable roller supported by an outer circumference of the protrusion.

4. The printing apparatus according to claim 1, wherein the abutting portion is an edge of a slot or a protrusion, the edge of the slot or the protrusion being formed parallel with an accommodated object to be printed and orthogonal to the first direction and extending along a third direction orthogonal to the second direction perpendicular to the first direction.

5. The printing apparatus according to claim 1, wherein the rotating portion of the positioner has a plurality of convex portions or a plurality of concave portions formed at predetermined angle intervals around the rotation axis,
wherein the positioner further comprises an engaging portion, the engaging portion being supported by either the printing unit or the housing and engaging with the plurality of convex portions or the plurality of concave portions.

6. The printing apparatus according to claim 2, wherein the carriage further comprises another second direction rack extending along the second direction, and
wherein the printing unit comprises: a support that supports the carriage slidably in the second direction; a second gear that meshes with the other second direction rack; and a first motor that rotationally-drives the second gear.

7. The printing apparatus according to claim 1, wherein the housing comprises: a gear group comprising at least one rotating input gear supported by the housing; a second motor that drives the input gear; a driven shaft that extends along a second direction, is secured on the center of rotation of one gear of the gear group, and rotates according to the rotation of the one gear; and driven gears disposed at both ends of the driven shaft, and
wherein the printing unit comprises a third direction rack being at both sides in the second direction of the printing unit, the third direction rack being on a plane parallel with an accommodated object to be printed on, extending along a third direction orthogonal to the second direction, and meshing with the driven gear.

8. The printing apparatus according to claim 7, wherein the printing unit comprises a through hole that extends along the third direction and into which the driven shaft is inserted.

9. A method of adjusting the printing gap using the printing apparatus according to claim 1, the method comprising:
rotating a rotating portion supported by either a printing unit or a housing which is rotated to rock an eccentric portion disposed at a position eccentrically apart from a rotation axis of the rotating portion, thereby rocking an abutting portion that is formed at the other of the either the printing unit or the housing and abuts against the eccentric portion during traveling in a first direction parallel with a printing direction.
